(19) United States
(12) Patent Application Publication
(10) Pub. No.: US 2010/0118463 A1
(43) Pub. Date: May 13, 2010

(54) SURGE ARRESTER WITH MOUNTING BRACKET

(76) Inventor: Timothy S. SMITH, Morrisville, NC (US)

Correspondence Address: TYCO TECHNOLOGY RESOURCES, 4550 NEW LINDEN HILL ROAD, SUITE 140, WILMINGTON, DE, 19808-2952, US

(21) Appl. No.: 12/266,852

(22) Filed: Nov. 7, 2008

(51) Int. Cl. H02H 9/06

(52) U.S. Cl. 361/117

(57) ABSTRACT

An arrester assembly is disclosed. The assembly includes a surge arrester, a disconnector attached to the surge arrester, and a mounting bracket disposed intermediate the surge arrester and the disconnector. The mounting bracket has a first end and a second end, the first end arranged and disposed for attaching the mounting bracket to a support. The mounting bracket further includes a collar extending away from the second end of the surge arrester to surround the disconnector and to provide a mechanical interface to resist rotational movement of the disconnector with respect to the mounting bracket.

### FIELD

The present invention relates to a surge arrester and more particularly to a surge arrester having a disconnector that disconnects the surge arrester from ground in the event of a failure of the surge arrester.

### BACKGROUND

Surge arresters are devices arranged to protect other electrical equipment, usually in the distribution and supply of electric power, from an excessively high and usually damaging electric voltage caused, for example, by a lightning strike. The surge arrester is electrically connected between equipment at high voltage and earth potential (i.e., ground) and is electrically insulating in the absence of the overvoltage, such that electrical current travels normally through the distribution network. On occurrence of an overvoltage condition, the surge arrester becomes conductive so as to safely divert the consequent current to ground.

In some instances, a lightning strike may occur sufficiently close to a surge arrester such that the electrical power that flows through the arrester is so intense as to damage or destroy it. In less extreme cases, the damage may result in the formation of a continuous current path to ground, i.e., a fault. A surge arrester can also be subject to other fault conditions.

Disconnectors are sometimes used to isolate a failed arrester from the applied voltage or from ground. Upon detection of a predetermined fault condition, usually a flow of a minimum current for a minimum time, the disconnector is arranged to physically separate from the surge arrester. This separation interrupts the path to ground, and usually occurs by explosive separation.

During installation or repair of a surge arrester, a lineman may apply excessive torque to the disconnector when attaching it to the surge arrester. This can result in the disconnector breaking and/or its premature failure.

What is needed is a way to shield the disconnector in a surge arrester from inadvertent over-torquing by an installer without impeding the disconnector's ability to function in the event of an explosive separation of the disconnector from the arrester during an overvoltage condition.

### SUMMARY

According to an exemplary embodiment of the invention, an arrester assembly is disclosed. The arrester assembly includes a surge arrester, a disconnector attached to the surge arrester and a mounting bracket disposed intermediate the surge arrester and the disconnector. The mounting bracket has a first end and a second end, the first end arranged and disposed for attaching the mounting bracket to a support. The mounting bracket further has a collar extending away from the second end of the surge arrester. The collar surrounds the disconnector and provides a mechanical interface to resist rotational movement of the disconnector with respect to the mounting bracket, such as in the presence of an external torsional force.

According to another exemplary embodiment of the invention, an arrester assembly includes a surge arrester, a disconnector and a mounting bracket. The disconnector has an upper fitting, a lower fitting having a ground stud extending away from the lower fitting, and a housing connecting the upper fitting to the lower fitting. The disconnector is attached to the surge arrester via the upper fitting. The mounting bracket is intermediate the surge arrester and the disconnector. The mounting bracket has a first end and a second end, the first end arranged and disposed for attaching the mounting bracket to a support. The mounting bracket also has a collar at the second end extending away from the surge arrester and surrounding the disconnector. The lower disconnector fitting has a head having between four to eight planar faces. The mounting bracket collar has an inner passage having a first width defined by a first set of inner collar walls and a second width defined by a second set of inner collar walls. The second set of inner collar walls are configured complementary to the lower fitting head. The collar provides a mechanical interface to resist rotational movement of the disconnector with respect to the mounting bracket but does not restrain axial travel of the disconnector.

An advantage of certain exemplary embodiments described herein is that the collar of the mounting bracket reduces the likelihood that a lineman or other individual installing a surge arrester will apply excessive torque to the disconnector and/or if applied, the excess torque is distributed to the mechanically more robust mounting bracket.

An advantage of certain other exemplary embodiments is that the collar surrounds, but does not restrain, the disconnector and thereby does not impair proper operation of the surge arrester in the event of an explosive separation of the disconnector from the arrester.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a surge arrester mounted using a mounting bracket.

FIG. 2 illustrates a perspective view of a mounting bracket in accordance with an exemplary embodiment of the invention.

FIG. 3 illustrates a top view of the mounting bracket of FIG. 2.

FIG. 4 illustrates a partial cross section of a surge arrester mounted to the mounting bracket of FIG. 2.

Where like parts appear in more than one drawing, it has been attempted to use like reference numerals for clarity.

### DETAILED DESCRIPTION OF EXEMPLARY EMBODIMENTS

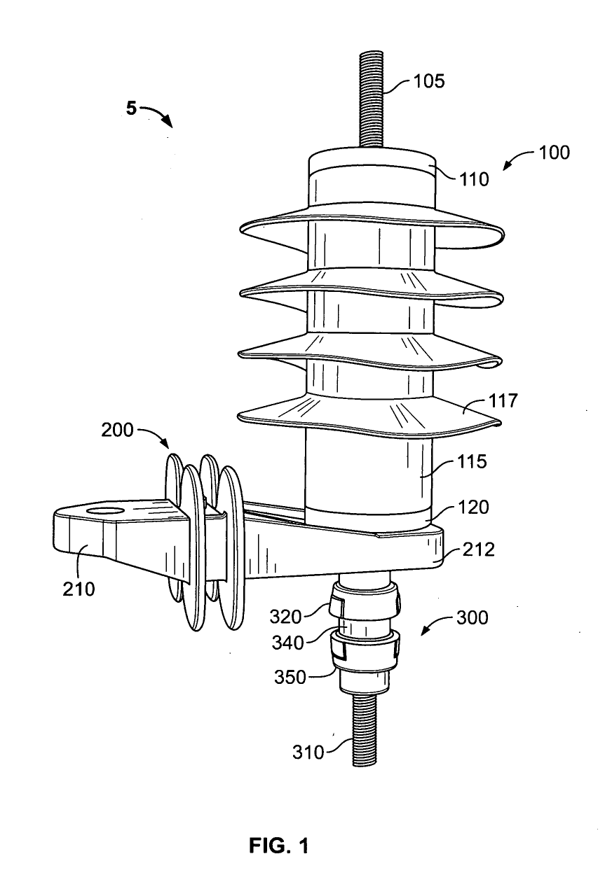

Referring to FIG. 1, an arrester assembly 5 is shown including a surge arrester 100, a mounting bracket 200, and a disconnector 300. The surge arrester 100 includes one or more varistor elements (not shown) contained within a housing 115. The housing 115 can include one or more sheds 117 for increasing the surface leakage current path. The housing 115, including any sheds 117, is made of a tracking resistant material, such as silicone or appropriately formulated polyolefin polymers and copolymers like ethylene-vinyl acetate copolymer (EVA), ethylene-propylene-diene monomer terpolymer (EPDM), and ethylene-propylene rubber (EPR) all by way of example only.

The arrester 100 also has conductive end caps 110, 120 at opposite ends of the arrester 100. The end caps 110, 120 make electrical contact with the varistors within the arrester 100, either directly or indirectly such as via conductive terminals within the housing 115. The conductive terminals (also not shown) are positioned at opposing ends of the varistors. A line stud 105 is provided from the first end cap 110 for electrically connecting the arrester 100 to a distribution network.

The disconnector 300 includes an upper fitting 320 that attaches to the arrester 100 in any suitable manner, for example, via a connection stud (not shown) that permits the disconnector to be screwed to the arrester 100. The disconnector 300 also includes a lower fitting 350 having a conductive ground stud 310 that provides a connection from the arrester 100 to ground. A housing 340 connects the upper and lower fittings 320, 350 and is positioned therebetween. The housing 340 is sized to protect functional components of the disconnector 300 that may include a resistor and one or more electrodes (not shown) that form a conductive pathway between the upper and lower fittings 320, 350 (and thus from the arrester 100 to the ground stud 310). The housing 340 is preferably constructed of a phenolic or other plastic and has a wall thickness such that upon the occurrence of a significant fault, the pressure of discharge gases formed within the arrester 100 causes the housing 340 to break apart. As a result of the breakage, the housing 340 no longer has sufficient strength to connect the upper fitting 320 to the lower fitting 350. This allows the lower fitting 350 and ground stud 310 to fall away (typically by gravity), thereby separating the arrester 100 from the ground connection to remove the fault. The wall thickness of the housing 340 to achieve this desired result generally corresponds to a housing 340 that can resist up to about 20 foot-pounds of torque without cracking. In another embodiment the housing 340 may resist up to about 45 foot-pounds of torque without cracking. Other embodiments may be designed for more or less torque depending on the application.

Preferred surge arresters and disconnectors for use in exemplary embodiments of the invention are those which form the DAR and DAH IEEE Bowthorpe EMP arrester systems available from Tyco Electronics Corporation of Berwyn, Pa.

The mounting bracket 200 is constructed of an insulating material and is disposed intermediate the arrester 100 and the disconnector 300. In one embodiment, the bracket 200 is constructed of a glass-filled polyester resin. The bracket has a first end 210 for mounting to a support, such as an electric pole, for example, and a second end 212 to support the arrester 100 which sits on an upper surface of the second end 212. An aperture (not shown) in the second end 212 permits the upper fitting 320 to be connected to the surge arrester 100.

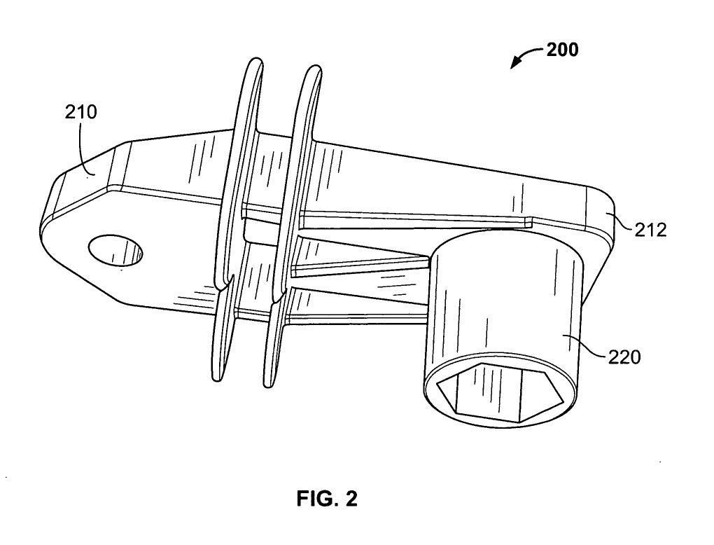

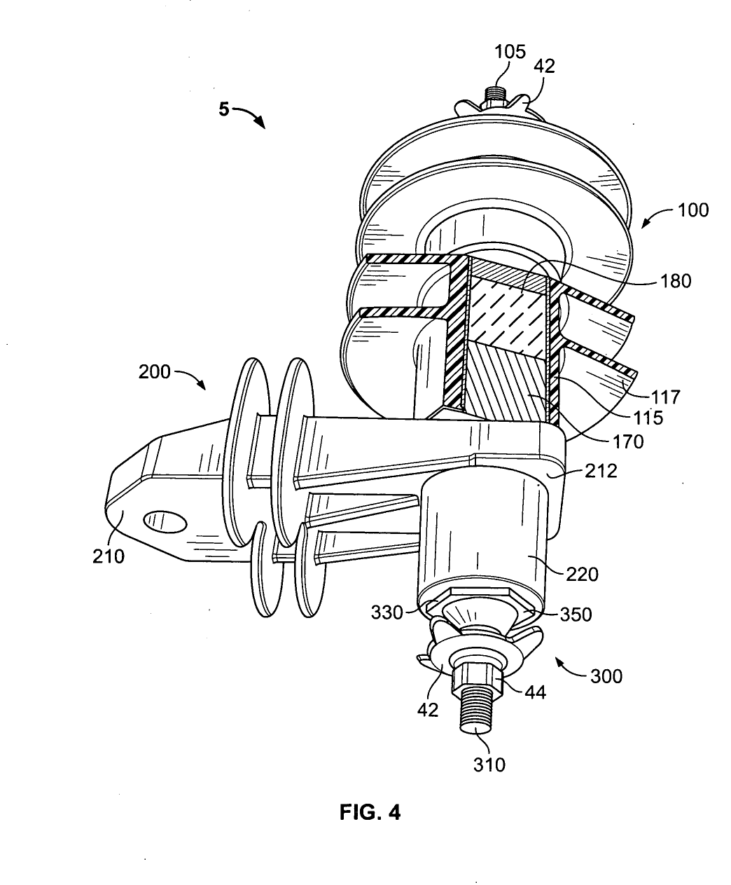

Turning to FIG. 2, in one embodiment the mounting bracket 200 includes a collar 220 extending away from a lower surface of the second end 212 (i.e., the surface opposite that which supports the surge arrester 100). The collar 220 extends to surround the disconnector 300, and more particularly to entirely surround the upper fitting 320 and disconnector housing 340 and to at least partially surround the lower fitting 350 (best seen in FIG. 4). The collar 220 provides a mechanical interface to resist rotation of the disconnector 300 when disposed within the collar 220.

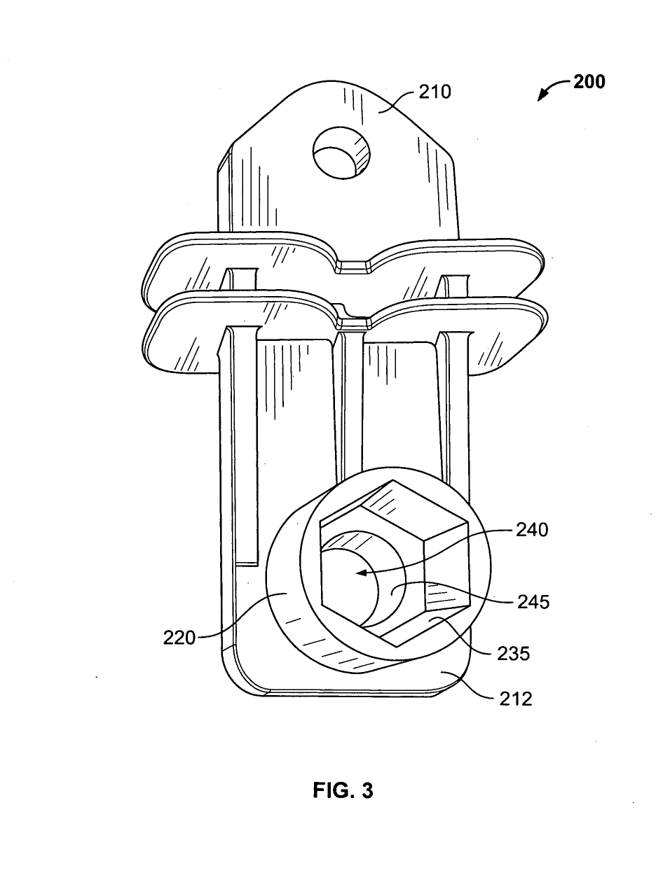

FIG. 3 illustrates a bottom view of the bracket 200 looking into the collar 220. The collar 220 has an inner passage 240 defined by inner collar walls 245 and which passes entirely through the bracket to permit the upper fitting 320 to be attached to the surge arrester 100. In a preferred embodiment, the inner passage has a second width defined by second inner collar walls 235, the second width being wider than that defined by the first set of inner collar walls 245. The shape of the inner collar walls 235, 245 may be complementary to the disconnector 300. Preferably, the second inner collar walls 235 are of a shape and size complementary to the lower disconnector fitting 350 in a nut and socket relationship.

When used in conjunction with a collar 220 having inner collar walls 235 complementary to the lower disconnector fitting 350, the nut and socket relationship allows the mounting bracket 200 to be used as a tool to attach the disconnector 300 to the surge arrester 100. The disconnector 300 can be disposed inside the collar 220 of the mounting bracket 200. The mounting bracket 200 and disconnector 300 can then together be rotated in order to screw the disconnector 300 to the surge arrester 100. In one embodiment, the lower disconnector fitting 350 (FIG. 4) includes a head having between four to eight planar faces 330 and preferably has six planar faces (i.e., is a hex head). Using fewer than four or greater than eight planar faces may result in undesirable slipping of the mounting bracket 200 with respect to the disconnector 300 during assembly.

If excessive torque is applied to the lower disconnector fitting 350 during installation, the torsional strain and cantilever stress is transferred to the collar 220 and not the disconnector housing 340, as rotation of the lower disconnector fitting 350 is opposed by the complementary inner collar walls 235. The collar 220 has a higher resistance to breaking (typically 50 foot pounds of torque or greater) than the disconnector housing 340. Thus, the risk that the disconnector housing 340 will be cracked during installation and that the disconnector 300 will fail prematurely is decreased.

FIG. 4 illustrates a completed arrester assembly 5 using the mounting bracket 200 of FIGS. 2 and 3, which includes the collar 220 surrounding the disconnector 300. Here, the lower half of the arrester 100 is shown partially cut away, illustrating a lower terminal 170 and a varistor element 180 within the arrester housing 115. FIG. 4 further illustrates that a clamp 42 may be provided on the ground stud 310 that can be tightened, for example, using a nut 44 or other fastener to retain a cable and thereby complete the ground connection to the surge arrester 100. Similarly, a clamp 42 may also be provided on the line stud 105 for attaching a power conductor to the surge arrester 100.

Preferably, while the collar 220 surrounds the disconnector 300, the collar 220 does not restrain axial travel of the disconnector 300. That is, the mounting bracket 200 does not support the disconnector 300 such that but for the disconnector 300 being attached to the surge arrester 100, the disconnector would be free to fall out of the collar 220.

In many conventional surge arrester designs, the disconnector is a single unit containing an explosive shell and filled with epoxy. In the event of a lightning strike, the explosive shell is detonated and the disconnector is forced away from the arrester to disconnect or isolate the fault from the line. Conversely, disconnectors ordinarily used with exemplary embodiments of the invention do not employ an embedded explosive and achieve separation of the disconnector 300 primarily from the explosion of the fault itself, which causes the housing 340 to break as described above. To ensure the ground connection is removed, the disconnector 300 can more reliably separate from the arrester 100 by allowing the lower fitting 350 to fall away completely unrestrained by the mounting bracket collar 220.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An arrester assembly comprising:
a surge arrester;
a disconnector attached to the surge arrester; and
a mounting bracket disposed intermediate the surge arrester and the disconnector, the mounting bracket having a first end and a second end, the first end arranged and disposed for attaching the mounting bracket to a support, the mounting bracket further having a collar extending away from the second end of the surge arrester to surround the disconnector and to provide a mechanical interface to resist rotational movement of the disconnector with respect to the mounting bracket.

2. The arrester assembly of claim 1, wherein the disconnector comprises an upper fitting attached to the surge arrester, a lower fitting having a ground stud extending away from the lower fitting, and a housing connecting the upper fitting to the lower fitting.

3. The arrester assembly of claim 2, wherein the lower fitting has a head having between four to eight planar faces.

4. The arrester assembly of claim 3, wherein the collar has inner collar walls formed to a shape and size complementary to the lower fitting head.

5. The arrester assembly of claim 1, wherein the mounting bracket collar has an inner passage having a first width defined by a first set of inner collar walls and a second width defined by a second set of inner collar walls that is wider than the first width.

6. The arrester assembly of claim 5, wherein the second set of inner collar walls are configured in a hexagonal shape.

7. The arrester assembly of claim 1, wherein the collar surrounds the disconnector without restraining axial travel of the disconnector.

8. The arrester assembly of claim 7, wherein the collar is configured complementary to the disconnector.

9. The arrester assembly of claim 1, wherein the mounting bracket forms an arrester assembly tool for attaching the disconnector to the surge arrester.

10. The arrester assembly of claim 1, wherein the mounting bracket is constructed of a glass filled polyester material.

11. The arrester assembly of claim 1, wherein the disconnector comprises a metallic component and a phenolic component.

12. An arrester assembly comprising
a surge arrester;
a disconnector comprising an upper fitting, a lower fitting having a ground stud extending away from the lower fitting, and a housing connecting the upper fitting to the lower fitting, the disconnector being attached to the surge arrester via the upper fitting; and
a mounting bracket disposed intermediate the surge arrester and the disconnector, the mounting bracket having a first end and a second end, the first end arranged and disposed for attaching the mounting bracket to a support, the mounting bracket furthering having a collar at the second end extending away from the surge arrester and surrounding the disconnector,
wherein the lower disconnector fitting includes a head having between four to eight planar faces,
wherein the mounting bracket collar has an inner passage having a first width defined by a first set of inner collar walls and a second width defined by a second set of inner collar walls, wherein the second set of inner collar walls are configured complementary to the lower fitting head, and
wherein the collar provides a mechanical interface to resist rotational movement of the disconnector with respect to the mounting bracket but does not restrain axial travel of the disconnector.

13. The arrester assembly of claim 12, wherein the disconnector housing is constructed of a phenolic material.

14. The arrester assembly of claim 12, wherein the mounting bracket is constructed of a glass-filler polyester.

15. The arrester assembly of claim 12, wherein the disconnector housing can resist up to about 20 foot pounds of torque without cracking.
